(19) United States
(12) Patent Application Publication
(10) Pub. No.: US 2021/0199578 A1
(43) Pub. Date: Jul. 1, 2021

(54) DEVICE AND METHOD FOR VISIBILITY MEASUREMENTS

(71) Applicant: UNIVERSITA' DEGLI STUDI DI TRENTO, Trento TN (IT)

(72) Inventors: Leonardo RICCI, Trento TN (IT); Mario SCOTONI, Trento TN (IT)

(21) Appl. No.: 17/057,748

(22) PCT Filed: May 28, 2019
(86) PCT No.: PCT/IB2019/054406

§ 371 Date: Nov. 23, 2020

(30) Foreign Application Priority Data
May 29, 2018 (IT) 102018000005817

(51) Int. Cl. G01N 21/53; G06T 7/00

(52) U.S. Cl. CPC G01N 21/538; G06T 7/00

(57) ABSTRACT

An automated device and a method to carry out visibility measurements are described. The device has an optical system comprising a camera (20), at least one sample image (IMC), and a first flat mirror (S1) and a second flat minor (S2) arranged in mutually different positions in order to generate two reflected images (IM1, IM3) of at least part of the sample image (IMC) at different optical distances with respect to the camera. The device further comprises a processing unit configured to determine a luminance contrast of each of the two reflected images (IM1, IM3) and calculate an instant value representing the visibility from a ratio between the two luminance contrasts.

### FIELD OF THE INVENTION

The present invention relates to an automated device and a method for measuring visibility, the latter defined in terms of meteorological optical range in the following abbreviated to MOR acronym.

The international reference document for the visibility measurement is “Guide to Meteorological Instruments and Methods of Observation” (hereinafter GMIMO) published in 2014 by the “World Meteorological Organization” (WMO) and updated in 2017.

Among the various quantities defined in this document, the quantity MOR is defined as follows: “MOR, Meteorological Optical Range: length of path in the atmosphere required to reduce the luminous flux in a collimated beam generated by an incandescent lamp at a temperature of 2700 K, at 0.05 times its original value”

The definition of the quantity MOR is based on a physically significant measurement. By applying the Lambert-Beer's law (named Bouguer-Lambert's in the GMIMO publication), one has:

F(x)=F₀e^{-xσ}, (1)

where F₀ is the luminous flux at x=0, F(x) that in x, and σ is defined as extinction coefficient. The value of x is thus given by:

$$x = - \frac{1}{σ} ln \frac{F ( x )}{{F}_{0}}$$

By definition

MOR=x⇔F(x)/F₀=0.05. (2)

In the GMIMO publication, the ratio F(x)/F0 is defined as transmission factor T (and the quantity MOR is given an additional symbol, P). Therefore it must result:

$$MOR = - \frac{1}{σ} ln ( 0.05 ) = \frac{ln ( 20 )}{σ} \qquad ( 3 )$$

In conclusion, if the transmission factor T is measured on a reference distance (baseline) b, the quantity MOR is equal to:

$$MOR = - b \frac{ln ( 20 )}{ln T} \qquad ( 4 )$$

The GMIMO publication further defines the luminance contrast C of an object with respect to its background as “the ratio between the difference between the object luminance and its background and the background luminance”; the contrast threshold ϵ is instead defined as “the minimum value of the luminance contrast detectable by human eye, i.e. the value that allows the object to be distinguished from the background”. As an instant footnote of the definition, the document specifies that “the contrast threshold varies from individual to individual”. Nevertheless, the GMIMO document assigns the contrast threshold ϵ the value of 0.05, that not surprisingly corresponds to the reference of the transmission factor for the computation of the quantity MOR.

### PRIOR ART

Various devices and instruments are known for measuring the visibility in terms of MOR, such as for example the single step, double step or multiple step transmissometers.

The U.S. Pat. No. 3,772,525 describes for example a multiple step transmissometer wherein angular mirrors are used to deviate the light pulses and discriminate the different back-reflections over time.

In addition to the transmissometers, instruments such as for example backscattering lidars (light detection and ranging) are in general used, of the type also used for measuring cloud height, as well as instruments for measuring the scattering coefficient (scatter meters), in which one or more sensors measure the light produced by a defined source and scattered by the atmosphere, then relating the scattering to the absorption coefficient and thus the quantity MOR. Lidars have a similar operating principle. The substantial difference relates to the position of the sensors for detecting the scattered light: in lidars, such a position essentially coincides with that of the source, whereas in the afore mentioned tools, and in particular for the more reliable forward scatter tools, the sensors are positioned out of the beam axis and observe the same under an angle that typically varies between 20° and 50°.

According to the GMIMO document, the instruments for measuring the scattering coefficient are generally less performing than the transmissometers, both in terms of systematic error and random error, at least as regard to low MOR values. Furthermore, they seem to be more affected by atmospheric precipitations despite being little susceptible to contaminations of the optical parts thereof.

### SUMMARY OF THE INVENTION

That being stated, it is an object of the present invention to provide an automated device for measuring the visibility that is constructively easy and that can be put in operating conditions in short times.

It is another object of the present invention to propose an automated device for measuring the visibility that does not require specific setting-up adjustments.

It is a further object of the present invention to propose an automated device for measuring the visibility, which has reduced sizes and is easily transportable.

These and other objects are achieved by the present invention thanks to a device for measuring the visibility according to claim 1. Further peculiar features of the device according to the invention are set forth in the respective dependent claims.

The automated device for measuring the visibility according to the present invention comprises specifically at least one sample image and at least two flat mirrors arranged in mutually different positions in order to generate at least two reflected images of at least part of the single sample image at different optical distances with respect to the camera. The camera is connected to a processing unit for determining the luminance contrast of each of the two reflected images and thus determining the measurement of the visibility starting from the ratio between the two luminance contrasts.

The use of a single sample image and two flat mirrors simplifies the overall structure of the device and makes the optical system setting-up operations particularly simple. Specifically, two reflected images can be provided that have the same lighting, whether natural or artificial, since they are obtained from a single sample image. Furthermore, it has been advantageously found that the lightning level does not affect the luminance contrast, and thus the visibility determination.

In a possible embodiment, the reference optical axis of the optical system coincides with the axis perpendicular to a first one of the two flat mirrors. The optical system can be installed for example on a supporting frame comprising a longitudinal arm with axis parallel to the optical axis of the optical system and a transverse arm, perpendicular to the longitudinal arm, placed at an end of the longitudinal arm with its own centre lying on the same end of the longitudinal arm.

The first flat mirror, i.e. the one with axis coincident with the reference optical axis, is arranged at the opposite end of the longitudinal arm with respect to the transverse arm.

The camera is installed on the supporting frame at the intersection between the optical axis of the optical system with the plane orthogonal thereto and containing the transverse arm.

The remaining components of the optical system, i.e. the sample image and a second one of the two flat mirrors, can be installed on the transverse arm of the supporting frame. The sample image can for example be composed of figures containing different levels of gray, or of the image of the same camera that is reproduced as images reflected by the two flat mirrors.

With the arrangement adopted for the various components of the optical system, the measuring device is constructively simple as a whole and is easy to be set-up.

In an embodiment, a supporting element can be interposed between the transverse arm of the supporting frame and the second one of the two flat mirrors. The supporting element comprises means for adjusting the tilting of the second one of the two flat mirrors with respect to the reference optical axis.

The means for adjusting the tilting of the second mirror can include for example screws to allow a fine tuning of the mirror tilting in order to present the camera with the two reflected images side by side and/or partially overlapped.

In order to avoid the condensation on the mirrors, heating means combined with each one of the mirrors can be provided, such as for example suitably powered electrical conductors.

The optical system camera can also be provided with a suitable dichroic filter. For example, the use of a green dichroic filter allows the measurement of the luminance contrast to be concentrated on the green region of the spectrum, where the human eye has the maximum of its luminous efficacy, and the light interferences due for example to natural or artificial lightning to be reduced.

The invention further relates to a method for carrying out visibility measurements, comprising the steps of:

a) providing an optical system comprising a camera, a single sample image and at least two flat mirrors arranged in mutually different positions in order to generate at least two reflected images of at least part of the sample image at different optical distances with respect to the camera;

b) connecting the camera to a processing unit;

c) calibrating the optical system;

d) determining the instant luminance contrast of each of the two reflected images; and

e) calculating an instant value representative of the visibility starting from the ratio of the two luminance contrasts determined in step d).

The method provides that the camera lens focusing is adjusted at an optical distance intermediate between the different optical distances of the two reflected images. This way, the blur effect is about the same on both the reflected images. In combination with this expedient, the diaphragm opening can be further minimized, such as to increase the depth of field.

The reference optical axis of the optical system coincides with the axis perpendicular to a first one of the two flat mirrors, whereas a second one of the two flat mirrors is tilted by an angle θ with respect to the plane perpendicular to the reference optical axis.

During the steps for measuring the visibility, the processing unit is programmed for setting a reference matrix and a fit matrix that contain values representing the pixels belonging to the image captured by the camera. The luminance contrast determination and the evaluation of the value representing the visibility are obtained on the basis of the comparison among the values of the reference matrix and the fit matrix.

The method provides for the steps d) and e) to be cyclically repeated with predetermined period, at least equal to the processing time. A mean value of the instant values representing the visibility is further cyclically calculated with a period multiple of the predetermined period in which steps d) and e) are carried out. For example, the steps d) and e) can be cyclically carried out with period of one second and the mean value can be calculated every ten seconds. The step c) provides for calibrating the optical system by a comparison with the results of a reference visibilimeter comprising for example a laser beam source projected towards at least one first of the two flat mirrors and a laser beam detector connected to the processing unit for determining the laser beam power detected by the laser beam detector. The reference visibilimeter can for example be set as a single step one, exploiting the path between the laser beam source, the first one of the two flat mirrors and the laser beam detector.

### BRIEF DESCRIPTION OF THE DRAWINGS

Further characteristics and advantages of the present invention will be more evident from the following description, made by way of example, with reference to the attached drawings, in which:

FIG. 1 is a schematic view of the optical system of a device according to the present invention;

FIG. 2 is the optical diagram of the optical system of FIG. 1;

FIG. 3 is a schematic plan view of an embodiment of a device according to the present invention;

FIG. 4 is a front view of some components of the device according to an embodiment of the present invention;

FIG. 5 is the image of a frame captured by the device camera;

FIG. 5A is a diagram of the frame of FIG. 5;

FIG. 5B is a diagram of another embodiment wherein the sample image consists of the same camera;

FIGS. 6 and 7 are plots showing the time pattern of some parameters calculated according to the method of the present invention during a test session;

FIG. 8 is a plot showing the time pattern of the luminance contrast and the transmission factor of the laser beam source during a test session;

FIG. 9 is a plot showing the ratio between the quantities of the plot of FIG. 8;

FIGS. 10A and 10B are plots showing the uncertainty estimation over time for some of the quantities calculated during a test session, respectively for single values and for the value means;

FIG. 11 is a plot showing the estimation, carried out during a test session, of one of the factors contributing to the systematic error in the measurements; and

FIGS. 12A and 12B are plots showing the accuracy estimation of the measurements over time carried out during a test session.

### DETAILED DESCRIPTION

The physical basis of the present invention consists of the Koschmieder's law (see for example the mentioned GMIMO publication), according to which the luminance contrast follows the same attenuation rule as the luminous flux:

C(x)=C₀e^{-xσ},

wherein Co is said inherent contrast while C(x) is said apparent contrast. From the Koschmieder's law it results that the visibility measurement can be carried out by evaluating the ratio between C(x) and C₀ exactly as if it were a luminous flux.

As it can be inferred by the afore mentioned equation (1), the ratio C(x)/C₀ has indeed the same pattern e^{-xσ} as the transmission factor T≡F(x)/F₀. It follows that the visibility, defined in the equation (2), can be determined by replacing in the equation (4) the transmission factor T by the ratio of the luminance contrast C(x)/C₀, defined in the following as ρ (p≡C(x)/C₀):

$$MOR = - b \frac{ln ( 20 )}{ln ρ} \qquad ( 5 )$$

wherein b is the length of the reference distance (baseline).

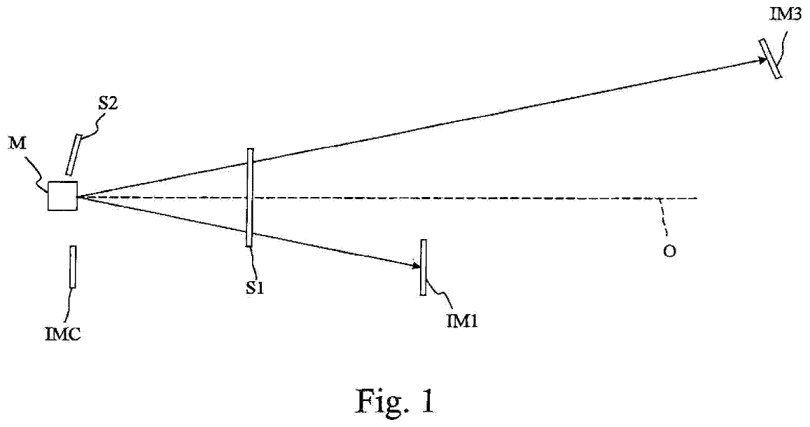

In the view of FIG. 1 an optical system of a device for measuring the visibility according to the present invention is schematically depicted, wherein there is a single sample image IMC and two flat mirrors S1 and S2 that generate two reflected images IM1 and IM3. Each one of the reflected images is arranged at a different optical distance from a meter M comprising for example a camera. The reference optical axis O of the optical system of FIG. 1 coincides with the axis of the flat mirror S1, i.e. with an axis perpendicular to the plane of the mirror S1.

From the layout of FIG. 1 it follows therefore that the device for measuring the visibility is based on a contrast meter that provides a single sample image IMC and two flat mirrors S1 and S2 which are able to generate the reflected images IM1 and IM3 having mutually different optical distances, for example with the second image IM3 at an optical distance close to twice that of the first image IM1. As it will be apparent from the following description, to the image IM3 has been assigned this numbering since it results by the multiplication of three reflections.

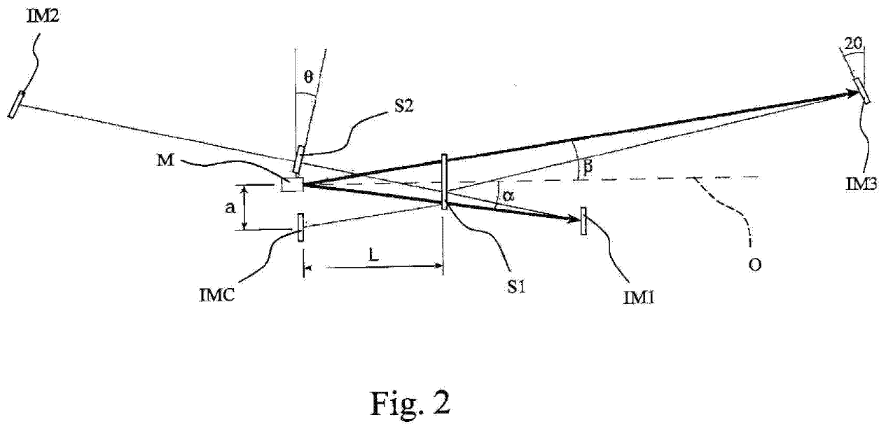

In fact, in the optical diagram of FIG. 2, the image IM2 that is generated by the flat mirror S2 and having the image IM1 as object, i.e. as source image, is also depicted. The image IM2 is invisible to the camera of a meter M since it is behind the optical plane of the camera. The image IM2 is thus reflected by the mirror S1, thus generating the image IM3 visible by the camera of the meter M, that thus “sees” the image IM1 and the image IM3. In practice, the image IM2, despite invisible to the camera of the meter M, is essential for the purposes of the operation of the device for measuring the visibility. The image IM2 would be visible to an observer positioned at the mirror S1 and facing the direction on the sample image IMC and the mirror S2.

As already highlighted above, the optical axis O of the optical system (also depicted in FIG. 2 with dashed line) is defined by the axis of the flat mirror S1 and coincides substantially with the longitudinal axis of the device. The optical input of the meter M, in this case constituted of the camera lens, is assumed as positioned in the origin of a system of Cartesian axes, with the axis of the abscissas coincident with the optical axis O facing the mirror S1 and the axis of the ordinates facing the mirror S2.

By assuming that the distance “a” is much smaller than the distance “L”, it results that the angle α, specified in radians and positive clockwise, under which the meter M “sees” the image IM1 to the right, is thus given by a/(2L).

This value is the approximation of the exact expression α=arctan a/(2L) that, based on the afore mentioned assumption, is α=a/(2L) with good approximation.

By defining θ as the tilt angle of the mirror S2 to the right (clockwise positive), and assuming θ<<1 (always in radians), the angle β, specified in radians and positive anticlockwise, under which the meter M “sees” the image IM3, is given approximatively by [θ−a/(4L)] and, therefore by [θ−α/2].

For completeness, the meter M “sees” the image IM1 rotated by an angle −α, i.e. a anticlockwise, with respect to its own vertical axis. Likewise, the meter M “sees” the image IM3 rotated by an angle [2θ−β] anticlockwise with respect to its own vertical axis.

However it should be noted that, since the number of reflections for the images IM1 and IM3 is odd, the two images have the same chirality.

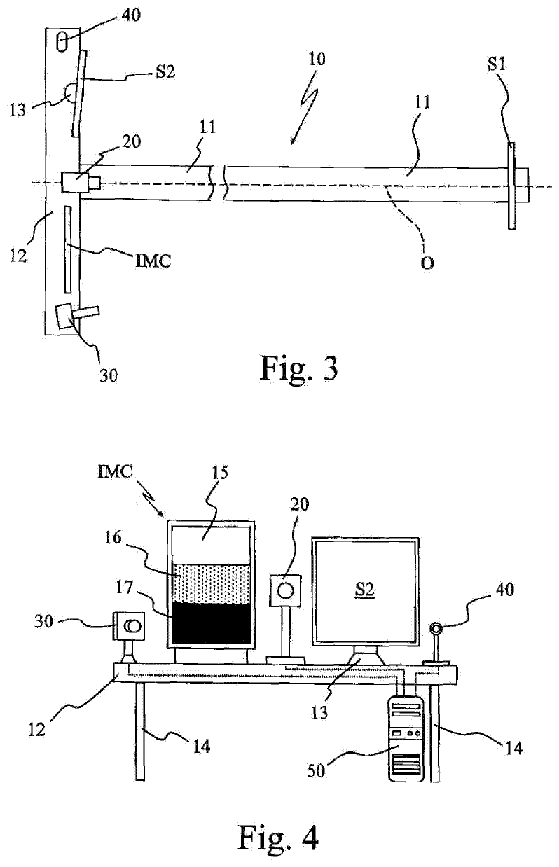

In FIGS. 3 and 4 the structure of an installation used in the test steps described hereinafter, in order to verify the precision and accuracy of a device for measuring the visibility according to the present invention, is schematically depicted. The optical system of the measuring device is installed on a supporting frame 10 comprising a longitudinal arm 11 with axis parallel to the optical axis O of the optical system and a transverse arm 12, perpendicular to the longitudinal arm 11, positioned at one end of the longitudinal arm 11 with its own centre lying on the same end of the longitudinal arm.

The flat mirror S1 is arranged at the opposite end of the longitudinal arm 11 with respect to the transverse arm 12 and is mounted on a rigid support, that still allows minimum adjusting levels.

The camera 20 of the measuring device is installed on the supporting frame 10 at the intersection between the optical axis O of the optical system with the plane orthogonal thereto and containing the transverse arm 12. An example of suitable camera can be the “DMK 21AU04 Monochrome Camera” model distributed by “The Imaging Source”. The optical system of the camera 20 comprises a proper photographic objective, typically a 50 mm one, and can be provided with a dichroic filter, such as for example the “Green Dichroic Filter 505 nm-575 nm” distributed by “Edmund Optics”, in order to reduce possible interferences caused by the lightning, or by the red laser beam during the calibration operations.

The sample image IMC and the second flat mirror S2 are installed on the transverse arm 12 of the supporting frame 10.

The sample image IMC can consist of figures containing different levels of gray and it can be made for example with an aluminium sheet on which upper part a white colored strip or sheet 15 is fastened (FIG. 4), followed in the center part by a gray colored sanded portion 16 and followed in its turn, in the lower part, by a black colored strip or sheet 17. The portions 15, 16 and 17 are however made of opaque material.

The flat mirror S2, having shape and sizes similar to those of the mirror S1, is mounted on the transverse arm 12 of the supporting frame 10 by means of a supporting element 13 interposed between the mirror S2 and the transverse arm 12. The supporting element 13 comprises screw means or similar means in order to finely adjust the tilting of the flat mirror S2 with respect to the reference optical axis O.

The flat mirrors S1 and S2 can be provided with heating means in order to avoid the condensation thereon. The heating means (not shown) can consist, for example, of suitable powered electrical conductors.

The output of the camera 20 is connected to the processing unit 50.

During the test and calibration steps a laser beam source 30 and a laser beam detector 40 are arranged on the same transverse arm 12. The components 30 and 40 provide a transmissometer that can be used in single step mode, (source 30-mirror S1-detector 40) or double step mode (source 30-mirror S1-mirror S2-detector 40), in order to provide the reference values to be compared to those of the measuring device according to the present invention in order to assess the uncertainty of the measurements thereof.

The laser beam source 30 can consist for example of a “CPS635F—Adjustable Focus Laser Diode Module, 635 nm, 4.5 mW” distributed by “Thorlabs Inc.” and suitably powered by a regulated power supply. The laser beam source is positioned such as to minimize the possible light interferences towards the measuring device according to the present invention.

The laser beam detector 40 can be for example a “S120C—Standard Photodiode Power Sensor, 400-1100 nm, 50 mW” model distributed by “Thorlabs Inc.” that allows the laser power to be measured. The output of the detector 40 is connected to a processing unit 50 (FIG. 4) through a suitable interface.

In the view of FIG. 4 the legs 14 bearing the supporting structure 10 in a position spaced apart from the ground are also highlighted. The horizontal plane containing the optical axis is at 0.95 m from the ground. It can be brought to the operating height prescribed by the WMO, of 1.5 m, with suitable extensions.

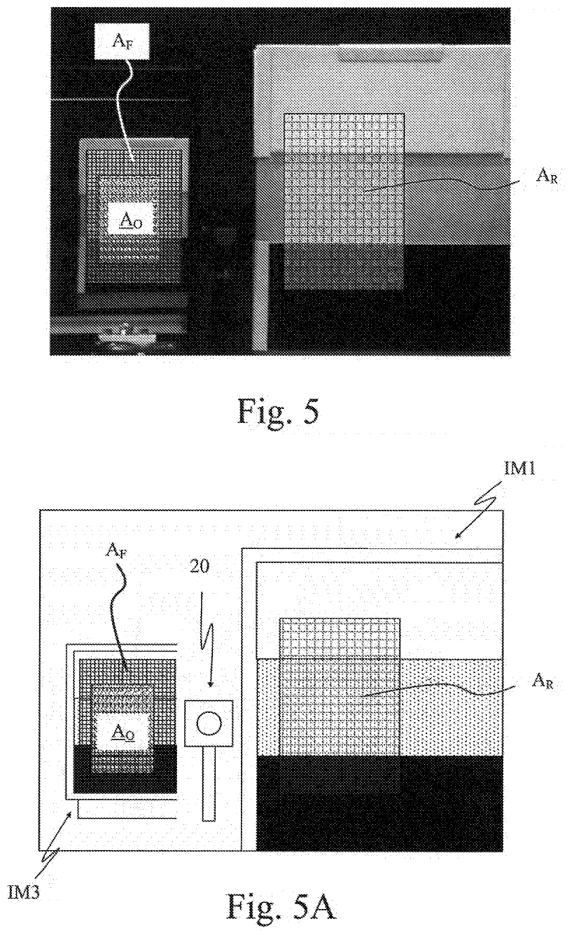

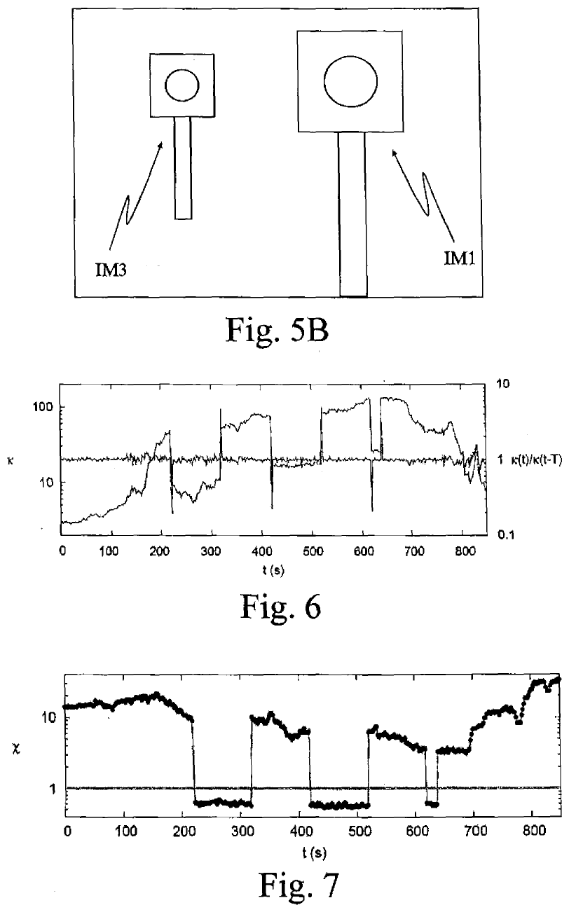

In FIGS. 5 and 5A a typical frame captured by the camera 20 in normal atmosphere (and thus with infinite visibility) is shown. It can be noted how the geometry of the reflected images IM1 and IM3 is consistent with the above description in relation to FIGS. 1 and 2. Furthermore, the luminance of the image IM3 generated by three reflections, is slightly lower than that of the image IM1 reflected only once. This is due to the reflectivity of the flat mirrors S1 and S2, typically equal to about 90%. In FIGS. 5 and 5A, the camera 20 “sees” itself slightly on the left. The tilting of the camera 20 is in fact set so as to contain in the frame the near totality of the images IM1 and IM3.

According to another embodiment, the sample image IMC can consist of the same camera 20, giving rise to reflected images IM1 and IM3 such as those depicted in FIG. 5B.

The method for carrying out visibility measurements is based on an algorithm executed by the processing unit 50 that determines the visibility from an image similar to that shown in FIGS. 5 and 5A.

A first function of the algorithm calculates a reference matrix R by giving each element thereof R_{k,j} the mean value of 4×4 contiguous pixels in the rectangular region AR in the images of FIGS. 5 and 5A. The matrix R has size M_{ref}×N_{ref}. It has to be noted that the first matrix index, k, corresponding to the matrix row, corresponds to the coordinate y of a Cartesian axis system (with the origin above and positive downwards, in accordance with the most usual agreement in the image processing); vice versa, the index j of the matrix columns corresponds to the coordinate x. By the same function the following three quantities are computed: W₀, W₁, W₂:

$${W}_{0} ≡ {\sum }_{j = 0}^{{M}_{ref} - 1} {\sum }_{k = 0}^{{N}_{ref} - 1} 1 = {M}_{ref} \cdot {N}_{ref} , \\ {W}_{1} ≡ {\sum }_{j = 0}^{{M}_{ref} - 1} {\sum }_{k = 0}^{{N}_{ref} - 1} {ℛ}_{k , j} , \\ {W}_{2} ≡ {\sum }_{j = 0}^{{M}_{ref} - 1} {\sum }_{k = 0}^{{N}_{ref} - 1} {ℛ}_{k , j}^{2} .$$

A second function of the algorithm calculates the reference matrix of the fit region F by giving each element F_{k,j} thereof the mean value of 2×2 contiguous pixels contained in the rectangular region A_{F} of the images of FIGS. 5 and 5A. The matrix F has size M_{fit}×N_{fit}. The size of the matrix in the fit region is larger than or equal to that of the rectangular reference region A_{R} since the computation of the mean values is indeed carried out on 2×2 contiguous pixels rather than on 4×4 contiguous pixels.

In a third function of the algorithm the reference matrix is overlapped in any possible way on a sub-matrix of the matrix of the fit region.

Given an overlapping, the object is to measure, by means of a proper figure of merit, the degree of overlapping between the fit matrix F and the reference matrix R, which is suitably transformed to take account of the variation of the base luminance and the luminance contrast. By virtue of the physical phenomena described afore, such a transformation is linear:

R→κ+ρ·r₀²·R, (6)

where r₀² is a factor that take account of the mirror reflectivity, κ takes account of the different luminance base level, and p coincides with the ratio of the luminance contrast that appears in the equation (5) already set forth above for the computation of the quantity MOR. The parameter ρ is thus the critical parameter for the purposes of determining the visibility. While r₀ is a priori measured (in an embodiment it resulted r₀=0.893), the parameters κ and ρ have to be determined by means of a data analysis procedure (fit), by optimizing the figure of merit.

As a figure of merit X the sum of the squared deviations among the elements of the fit matrix F and those of the reference matrix R, linearly “transformed” according to the preceding equation (6), has been selected:

$$χ ( κ , ρ ) ≡ {\sum }_{{j}^{′} = 0}^{{M}_{ref} - 1} {\sum }_{{k}^{′} = 0}^{{N}_{ref} - 1} {[ {ℱ}_{{k}^{′} , {j}^{′}} - ( κ + ρ \cdot {ℛ}_{{k}^{′} , {j}^{′}} ) ]}^{2}$$

The optimal values for κ and ρ are obtained by means of standard mathematical analysis techniques. The results are given by:

$$κ = \frac{R \cdot {W}_{2} - S \cdot {W}_{1}}{{W}_{0} \cdot {W}_{2} - {W}_{1}^{2}} , \\ ρ = \frac{1}{{r}_{0}^{2}} \frac{S \cdot {W}_{0} - R \cdot {W}_{1}}{{W}_{0} \cdot {W}_{2} - {W}_{1}^{2}} ,$$

where W₀, W₁, W₂ are the quantities calculated above from the first function of the algorithm, while the values R and S, with an additional value U, are defined hereinbelow:

$$R ≡ {\sum }_{j = 0}^{{M}_{fit} - 1} {\sum }_{k = 0}^{{N}_{fit} - 1} {k , j}_{}$$

$$S ≡ {\sum }_{j = 0}^{{M}_{fit} - 1} {\sum }_{k = 0}^{{N}_{fit} - 1} {ℱ}_{k , j} \cdot {k , j}_{}$$

$$U ≡ {\sum }_{j = 0}^{{M}_{fit} - 1} {\sum }_{k = 0}^{{N}_{fit} - 1} {ℱ}_{k , j}^{2}$$

At the end one gets:

X=U+κ²W₀+ρ²r₀⁴W₂−2κR−2ρr₀²S+2κρr₀²W₁

It is therefore provided the value ρ₀, i.e. the value of ρ occurring at the minimum value of the figure of merit X among all those resulting from the different overlappings.

In the images of FIGS. 5 and 5A, the rectangular region A_{O} represents by way of example only the overlapping corresponding to the optimal value of the figure of merit X.

In reference to the equation (4) for the computation of the quantity MOR, in a fourth function of the algorithm it is firstly verified that ρ₀ is larger than e^{-bIn(20)/Vmax}, where b is the length in meters of the reference distance (baseline) used, while Vmax is the predetermined supremum of visibility, specified in meters, for the present computation. If the value ρ₀ does not meet this condition, the visibility measurement, denoted by ν, is set to −1 (signaling an out of scale value). If on the contrary the value ρ₀ is within the preset limit, ρ₀ is transformed into visibility measurement ν by the equation (4). A ρ₀ piece of data is produced by the algorithm every τ seconds.

In order to obtain a visibility measurement averaged in a given time range and to simultaneously estimate the measurement accuracy (random error), the value ρ₀ is averaged together with the M−1 preceding values. Such an averaging operation is carried out provided that all the M consecutive values are valid, i.e. corresponding to visibility values μ within the measurement range between 0 and Vmax meters. The mean value <ρ₀> and the respective standard error δρ₀ at time t are calculated by the following expressions:

$$〈 {ρ}_{0} 〉 = \frac{1}{M} {\sum }_{i = 0}^{M - 1} {ρ}_{0} ( t - i \cdot τ )$$

$${δρ}_{0} = {[ \frac{1}{M \cdot ( M - 1 )} {\sum }_{i = 0}^{M - 1} {[ {ρ}_{0} ( t - i \cdot τ ) - 〈 {ρ}_{0} 〉 ]}^{2} ]}^{\frac{1}{2}}$$

Starting from <ρ₀> and δρ₀ a mean visibility measurement <ν> and the respective random error δν are produced by using the equation (4) for the computation of the quantity MOR and the error propagation:

$$〈 v 〉 = - b \frac{ln ( 20 )}{ln 〈 {ρ}_{0} 〉}$$

$$δ v = - \frac{〈 v 〉}{ln 〈 {ρ}_{0} 〉} \cdot \frac{{δρ}_{0}}{〈 {ρ}_{0} 〉}$$

A piece of data composed of the pair <ν>, δν is produced every τ seconds (in case of single values within the validity interval); being the result of a moving average on M elements, it is inferred that an averaged piece of data completely independent of the previous one is produced every Mτ seconds.

For example, by setting the number M equal to 10 and τ equal to one second, an averaged piece of data <ν>, δν completely independent of the previous one is produced every 10 seconds.

Experimental Results of Visibility Measurement

A prototype of a device according to the present invention has been provided wherein the components of the optical system have been arranged on a supporting frame 10 in accordance with what depicted in FIGS. 3 and 4. The longitudinal arm 11 of the supporting frame 10 had a length of 308 cm, while the transverse arm 12 had a length of 80 cm. The overall length of the reference distance (baseline) b was 6.02 meters. The tilt angle θ of the flat mirror S2 has been set to 1.5°. The visibility supremum Vmax is set to 500 meters.

The test and calibration measurements have been carried out in different sessions in a simulated environment consisting of a volume with a length of about 30 m, width of about 12 m and height of about 6 m, in which artificial mist is produced by means of a high-pressure water spraying system. The hydraulic lines containing the nozzles are placed at a height of 2.4 m along the two long sides of the environment. The simulated environment is provided with windows and is provided with artificial neon lighting.

As an additional visibility measuring device, the system comprising the laser beam source 30, the flat mirror S1 and the laser beam detector 40 described above has been used. The laser transmission factor ρₗₐₛₑᵣ is given by the ratio

$${ρ}_{laser} = \frac{P - {P}_{dark}}{{P}_{0} - {P}_{dark}}$$

where P is the instant power read by the detector 40, P₀ is the power read by the detector 40 in condition of normal atmosphere (and thus with infinite visibility), and P_{dark} is the power read by the detector 40 with shuttered laser. The value P_{dark} is about 20 μW during the day and with artificial lighting on, and 10 μW during the day but with artificial lighting off.

In a typical test measurement the starting point is a condition of normal atmosphere (and thus with infinite visibility). Powering up the spraying system produces a reduction of the visibility to values on the order of 10 meters. The visibility fall time depends on the water pressure in the spraying system, to which a less relevant dependence on the temperature of the simulated environment adds up. Typical fall times are on the order of 10 minutes. Upon the spraying system switched off, the visibility returns to normal levels in times of about 3÷10 minutes.

In most of the measurements carried out in multiple test sessions, a software version with τ set to 2 seconds has been used.

In FIG. 6 the time pattern of the parameter τ is shown. Of particular interest is the ratio between κ at time t and the preceding value, i.e. κ at time t−τ. Such a ratio, highlighted in the figure with a line ranging around the value 1, shows some peaks of about 5 and other of about ⅕. They correspond to the environment lighting variation operated by the artificial lighting switched off and on.

As depicted in FIG. 7, in which the time pattern of the parameter X is shown, the lighting variation also affects the time pattern of the figure of merit X: to a lighting reduction corresponds a lower value of the elements of the matrices R and F and thus of X. The steps of “high” and “low” lighting are thus distinguished by whether overcoming or not a threshold value, herein set to 1 and denoted by the horizontal line appearing in the plot.

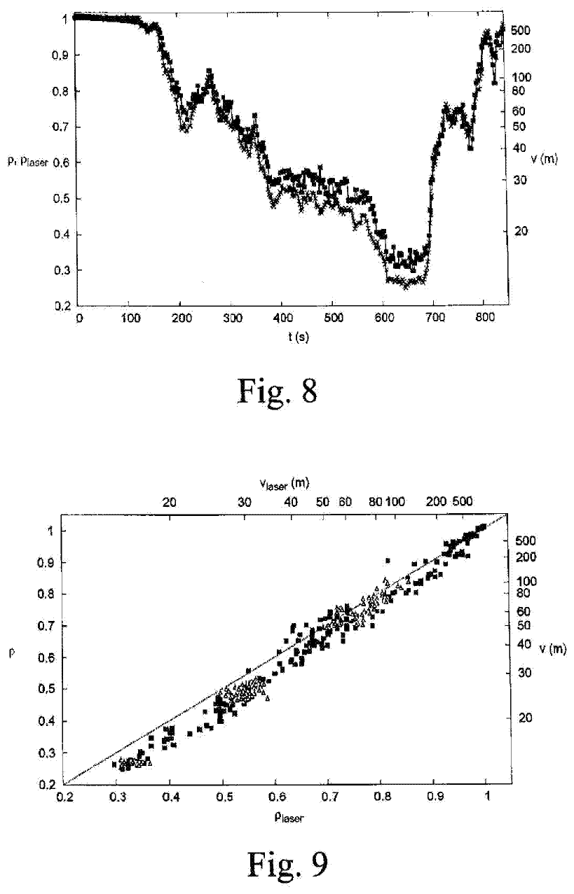

In FIG. 8 the time pattern of the luminance contrast parameter ρ is shown, denoted by squared dots, and of the laser transmission factor ρₗₐₛₑᵣ denoted by cross dots. On the right vertical scale the visibility ν calculated from ρ by using a reference distance (baseline) of 6.02 m (the scale difference to the one that would represent the visibility calculated by using a reference distance of 6.12 m is about 2%) is plotted. The dots appearing approximatively in the ranges 200-300 sec., 400-500 sec. and 600-650 sec. relate to “low” lighting steps, while the dots in the remaining ranges correspond to “high” lighting steps. Two aspects become apparent: the first, fundamental one, is that the lighting level does not affect the parameter ρ and thus the visibility determination ν.

The second aspect relates to a faint but “systematic” discrepancy between the two measurements, with ρₗₐₛₑᵣ slightly smaller than or nearly equal to ρ, due to the different reference distance (baseline) of the laser beam source, of about 6.12 m, with respect to the one of the remaining optical system, of about 6.02 m.

The independence of the luminance contrast parameter ρ, and thus of the visibility ν, of the lighting level becomes apparent also from FIG. 9, as well as from other following figures. Each dot corresponds to a pair of dots of the plot of FIG. 8, which are sampled at the same time. The triangular dots relate to “low” lighting conditions, while the squared dots relate to “high” lighting conditions. The diagonal line crossing the plot denotes the ideal straight line ρ=ρₗₐₛₑᵣ or, equivalently, ν=νₗₐₛₑᵣ. It is apparent the quasi-linear relation linking ρ and ρₗₐₛₑᵣ or, equivalently, ν and νₗₐₛₑᵣ. It has to be remarked that ν is calculated starting from p by using a reference distance (baseline) of about 6.02 m, νₗₐₛₑᵣ is calculated starting from ρₗₐₛₑᵣ by using a reference distance (baseline) of about 6.12 m.

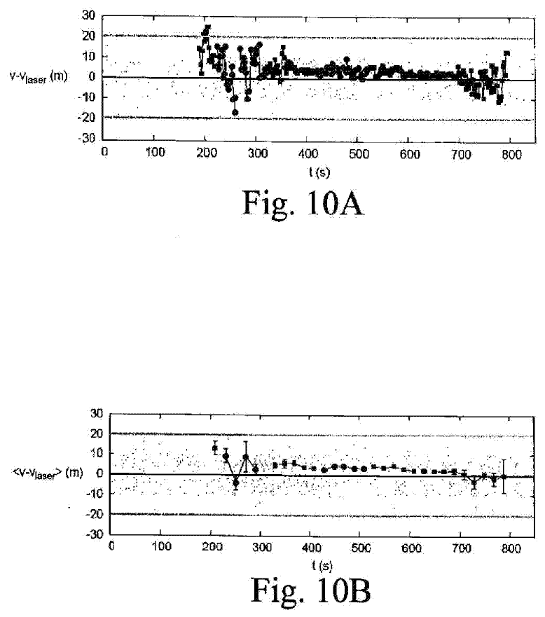

The difference between the two readings ρ and ρₗₐₛₑᵣ reported in FIGS. 10A and 10B provides an estimation of the system uncertainty. In these plots, the round dots relate to “low” lighting conditions, while the squared dots relate to “high” lighting conditions. The area comprised between ±20 m in the plots of FIGS. 10A and 10B represents the boundary region linked to the 20% uncertainty specifications. For FIG. 10A only the dots meeting the condition ν≤100 m have been taken into account and the values of the difference ν−νₗₐₛₑᵣ are shown. Each dot corresponds to a pair of dots of the plot of FIG. 8, which are sampled at the same time. For FIG. 10B only the dots for which ν≤100 m have been taken into account. The dots correspond to the mean value on 10 measurements <ν−νₗₐₛₑᵣ>. Each error bar associated with the plot dots is given by (δν²+δνₗₐₛₑᵣ²)^{1/2}. The area comprised between ±20 m represents the boundary region linked to the 20% uncertainty specifications. The uncertainty is given by the sum of the systematic error and the random error. The systematic error, expressing the accuracy of a measurement, is known to be the most difficult typology of error to be investigated in the characterization of any device, especially if reference “samples” are missing. Hereinbelow possible sources of the difference observed between the two readings are listed:
sensor non-linearity;
laser beam position 7 cm lower than the image centroid (the mist decreases with the height from the ground, also within the simulated environment);
different scattering at different wavelengths and for different sizes of water drops in suspension.

As regard to the effect of the height difference between the laser beam and the image centroid, in some test sessions two measurements have been carried out: one with standard configuration; the other one with laser and detector both raised by 145 mm (from 105 mm above the upper plane of the supporting frame to 250 mm), so that the height difference changed from −70 mm to +75 mm. The two measurements have been carried out in “high” lighting conditions and with r nearly equal to one second.

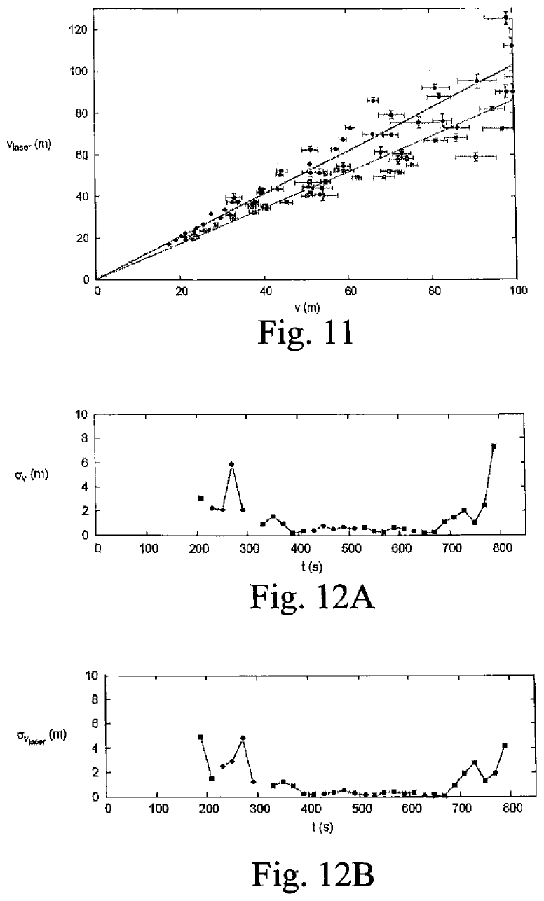

The result is shown in FIG. 11. The experimental data can be interpreted by the fact that, in standard configuration, the laser extinction coefficient σ is 1.17±0.02 times the one of the images, whereas in the “raised” configuration the laser extinction coefficient is 0.97±0.01 times the one of the images. These values correspond to the reciprocal of the angular coefficients of the linear regression lines showed in the plot of FIG. 11, as it follows from the equation (3). The linear regression has been carried out on such dots that <ν>≤100 m. If a linear dependence of the extinction coefficient (and thus of the mist particle density) on the height is assumed, a laser positioned on the horizontal plane containing the optical axis would have an extinction coefficient of 1.07 times the one of the image. The difference with respect to the unit could be ascribed to a light scattering by the mist proportional to the wavelength.

A further aspect relates to the random error estimate. For this purpose, FIGS. 12A and 12B show the random errors by only taking into account the dots meeting the respective conditions <ν>≤100 m and <νₗₐₛₑᵣ>≤100 m. The squared dots relate to “high” lighting conditions, while the round dots relate to “low” lighting conditions.

In FIG. 12A the values of σ_{ν} are depicted and in FIG. 12B the values of σ_{νlaser} are depicted, which are calculated on 10 measurements and corresponding to such mean values that <ν>≤100 m and <νₗₐₛₑᵣ>≤100 m.

The apparent similarity between the distributions of the random errors σ_{ν}e σ_{νlaser} is confirmed by the Kolmogorov-Smirnov's test (p-value>0.25 in the cases shown). It follows that the main random error source is the mist itself. In summary, on the basis of the experimental data discussed above, it may be concluded that, as a precautionary measure, by averaging on 10 values, the maximum uncertainty on the measurement is equal to 20 m within the interest range of 0-100 m.

In brief, the tests show that a device according to the present invention for measuring the visibility (MOR) with limited range fulfills the objects of the invention.

In particular, by assuming an average of 10 consecutive values:
the sum of the systematic error and random error estimates results in a maximum uncertainty on the visibility measurement of ±20 m within the interest range of 0-100 m;
an independent piece of data can be produced every 10 seconds;
a device according to the invention is transportable and can be operative in short times, estimated in about 30 minutes;
a device according to the invention does not require particular maintenance, except for maintaining the flat mirrors cleaned.

The performances of the prototype embodied, for example in terms of uncertainty, maximum range and predetermined period, can be directly improved without departing from the scope of the invention for example by means of the use of qualitatively better optical and electronic components.

Various modifications can be made to the embodiments described herein without departing from the scope of the invention. For example, for the use in low lighting conditions (for example nighttime), a suitable lighting of the sample image can be provided, or the sample image can be of the “active” type; the calibration problems are avoided by the fact that a device according to the present invention uses one sample image only which is “split” by the flat mirror system. The flat mirrors can also be more than two and the reflected images IM1, IM3 can be generated by multiple reflections.

Furthermore, a horizontally developed sample image can be provided, instead of a vertically developed one as the one herein described, and with a different distribution of levels of gray. The use of a sample image having circular symmetry can also be provided, in order to make easier and quicker the process of finding the best overlapping of the fit matrix with the reference matrix.

1. An automated device for visibility measurements, characterized by having an optical system comprising a camera (20), at least one sample image (IMC), and at least two flat mirrors (S1, S2) arranged in mutually different positions in order to generate at least two reflected images (IM1, IM3) of at least part of said sample image at different optical distances with respect to said camera (20) and a processing unit (50) to determine the luminance contrast of each of the two reflected images (IM1, IM3) and calculate an instant value representing the visibility from the ratio between the two luminance contrasts.

2. The device according to claim 1, wherein the reference optical axis (O) of the optical system coincides with the axis perpendicular to a first one (S1) of the two flat mirrors (S1, S2).

3. The device according to claim 1, further comprising a supporting frame (10) on which the optical system is installed, wherein the supporting frame (10) comprises a longitudinal arm (11) with axis parallel to the optical axis (O) of the optical system and a transverse arm (12), perpendicular to the longitudinal arm (11), with its own centre positioned at an end of the longitudinal arm (11).

4. The device according to claim 3, wherein said first flat mirror (S1) is arranged at the opposite end of the longitudinal arm (11) with respect to said transverse arm (12).

5. The device according to claim 3, wherein said camera (20) is installed on said supporting frame (10) at the intersection between the optical axis (O) of the optical system and the plane orthogonal to the optical axis and containing said transverse arm (12).

6. The device according to claim 3, wherein said sample image (IMC) and a second one (S2) of the two flat mirrors (S1, S2) are installed on the transverse arm (12) of said supporting frame (10).

7. The device according to claim 3, further comprising a supporting element (13) interposed between the transverse arm (12) of the supporting frame (10) and the second one (S2) of said two flat mirrors (S1, S2), said supporting element (13) comprising adjusting means to adjust the tilting of the second one (S2) of said flat mirrors (S1, S2) with respect to the reference optical axis (O).

8. The device according to claim 1, further comprising heating means that are combined with each one of said flat mirrors (S1, S2).

9. The device according to claim 1, wherein said sample image (IMC) is composed of figures containing different levels of gray or diffuse reflection coefficients.

10. The device according to claim 1, wherein said sample image (IMC) consists of said camera (20).

11. The device according to claim 1, wherein said camera (20) is provided with a filter for selecting a spectral region.

12. A method for carrying out visibility measurements, characterized by comprising the steps of:
a) providing an optical system comprising a camera (20), at least one sample image (IMC), and at least two flat mirrors (S1, S2) arranged in mutually different positions in order to generate at least two reflected images (IM1, IM3) of at least part of said sample image (IMC) at different optical distances with respect to said camera (20);
b) connecting said camera (20) to a processing unit (50);
c) calibrating the optical system;
d) determining the instant luminance contrast of each of the two reflected images (IM1, IM3); and
e) calculating an instant value representative of the visibility starting from the ratio between the two luminance contrasts determined in said step d).

13. The method according to claim 12, wherein the lens focusing of said camera (20) is adjusted at an optical distance intermediate between the different optical distances of said two reflected images (IM1, IM3).

14. The method according to claim 12, wherein the reference optical axis (O) of the optical system coincides with the axis perpendicular to a first one (S1) of the two flat mirrors (S1, S2), and wherein a second one (S2) of said two flat mirrors is tilted by an angle θ with respect to the plane perpendicular to the reference optical axis (O).

15. The method according to claim 12, wherein said processing unit (50) sets a reference matrix and a fit matrix, said matrices containing values representing the pixels belonging to the image captured by said camera (20), and wherein the luminance contrast determination and the evaluation of the value representing the visibility are obtained based on the comparison among the values of said reference matrix and said fit matrix.

16. The method according to claim 12, wherein said steps d) and e) are cyclically repeated with predetermined period.

17. The method according to claim 16, wherein a mean value of the instant values representing the visibility is cyclically calculated with a period which is multiple of said predetermined period in which said steps d) and e) are carried out.

18. The method according to claim 12, wherein said step c) provides calibrating the optical system by means of a comparison with the results of a reference visibilimeter comprising a laser beam source (30) projected towards at least one first (S1) of said flat mirrors (S1, S2) and a laser beam detector (40) to determine the laser beam power.

19. The method according to claim 12, wherein said reflected images (IM1, IM3) are generated by multiple reflections.

20. A computer program medium wherein a program comprising codes executable by a processing unit to carry out at least the steps d) and e) of the method of claim 12 is stored.
